(19) United States
(12) Patent Application Publication
(10) Pub. No.: US 2019/0021512 A1
(43) Pub. Date: Jan. 24, 2019

(54) MATTRESS MANUFACTURING PROCESS AND RESPECTIVE RESULTING PRODUCT

(71) Applicant: Carlito Selso MACHADO, Rio Grande do Sul (BR)

(72) Inventor: Carlito Selso MACHADO, Rio Grande do Sul (BR)

(21) Appl. No.: 15/652,956

(22) Filed: Jul. 18, 2017

(51) Int. Cl. A47C 27/00; A47C 27/14; A47C 27/15; B68G 7/00

(52) U.S. Cl. CPC A47C 27/001; B68G 7/00; A47C 27/15; A47C 27/148

(57) ABSTRACT

The invention refers to the manufacturing process of a mattress that presents divisions on the left and right sides (L_{E} and L_{D}), considering the body weight of each user (if the mattress is double), divisions in cross-sections (A, B and C), taking into account the differences in weight that exist between the various regions of the body (shoulders, hips, legs, etc.) and division into multilayers (9, 10, 11 and 12) for each of these cross-sections.

### TECHNICAL FIELD

The following descriptive report for invention refers to the mattress manufacturing process that presents divisions on the left side and right side, considering the body weight of each user (if the mattress is double), cross-sections, considering the weight differences that exist between the various regions of the body and the division into multilayers for each of these cross-sections.

### STATE OF THE ART

Mattresses manufactured with different densities is a common knowledge of the art. These mattresses can be stratified in layers of different densities, and can also be divided according to the body mass of each of its users. Mattresses that have different densities are common, for example, to adjust the differences between couples. A heavier user may require higher density than a lighter user. These differences may be very significant when the couples' body weight is very different, making it impossible to purchase a mattress with stratified densities, thus requiring a product that is divided longitudinally into two sections with different densities.

The document U.S. Pat. No. 5,231,717 describes a modular bed system comprising of a rigid non-elastic platform with depressions formed on its upper surface for receiving resilient pads and a relatively thin mattress supported over this platform and pads. In a preferable setting method, there is a depression and a pad located under the shoulders of a person reclining on the mattress of the bed system and a second pad located under the hips of a person reclining on the system. In another preferable setting, there is a single pad located in a single bed depression, but the pad extends under the shoulders and under the hips of a person reclining on the mattress and has a firmer under the person's waist.

A multi-density foam mattress is described in PI 0803269-6, which presents ends with lower-density foam, intended to support the legs and shoulders, and a central area with higher density foam to support the hips and thighs. A constructive option of the orthopedic mattress features ends with lower density foam, a central area with higher density foam and intermediate parts with medium density foam. Another constructive option of the orthopedic mattress presents ends with lower density foam, a central area with higher density foam and intermediate parts with progressive densities foams.

The document US 20110099722 describes reinforced mattresses having a mattress core and one or more reinforcement pads located near the mattress core, and corresponding to higher density point patterns in a padded layer which is located next to the reinforcement pads. One or more reinforcement pads are located in higher burden areas of the mattress, such as the pelvic area or the head and shoulders area, to provide additional support and to resist to or prevent permanent deformation of the mattress support surface.

In the case of document EP 0634124, if there is a mattress with a core that contains air channels, it is made of foamed material and/or latex and includes a plurality of sections with different hardness, each extending over the entire width of the mattress. The different degrees of hardness of the sections are determined by a different number of air channels provided for each section and/or different diameters of the air channels.

Another mattress of varied density can be seen in document MU 8603021-3, which has a central area with density higher than the other areas. The denser area is located in the center of the mattress to facilitate hips support in this area and prevent a disproportionate sinking of the body after laying on the mattress for a long period.

Also, document KR20040073827 describes a triple folding mattress, which is divided into an upper part, a middle part and a lower part. The divided parts include bodies, each comprised of an elastic cushioning element and an outer cover around the elastic element. The cushioning element that forms the central part is different from the cushioning elements that form the bodies of the upper and lower parts.

### SUMMARY

Thus, due to relevant considerations to the state of the art previously discussed, one of the purposes of this invention is the development of the mattress manufacturing process and respective product, comprehending the steps necessary for the manufacturing of the mattress with multi-densities distributed by multilayers in different sides, left-right and cross-sections.

### DESCRIPTION

The characterization of this invention is made through representative drawings of the mattress manufacturing process and respective resulting product in such a way that the equipment may be fully reproduced by proper technique, allowing full characterization of the claimed object functionality.

From the prepared figures expressing the best method or preferred method of producing the designed product, the descriptive part of the report is based through a detailed and consecutive numbering, where it clarifies aspects that may be implied by the representation adopted, in order to clearly determine the desired protection.

These figures are merely illustrative, and may present variations, provided that they do not diverge from the initially proposed.

In this case, there is:

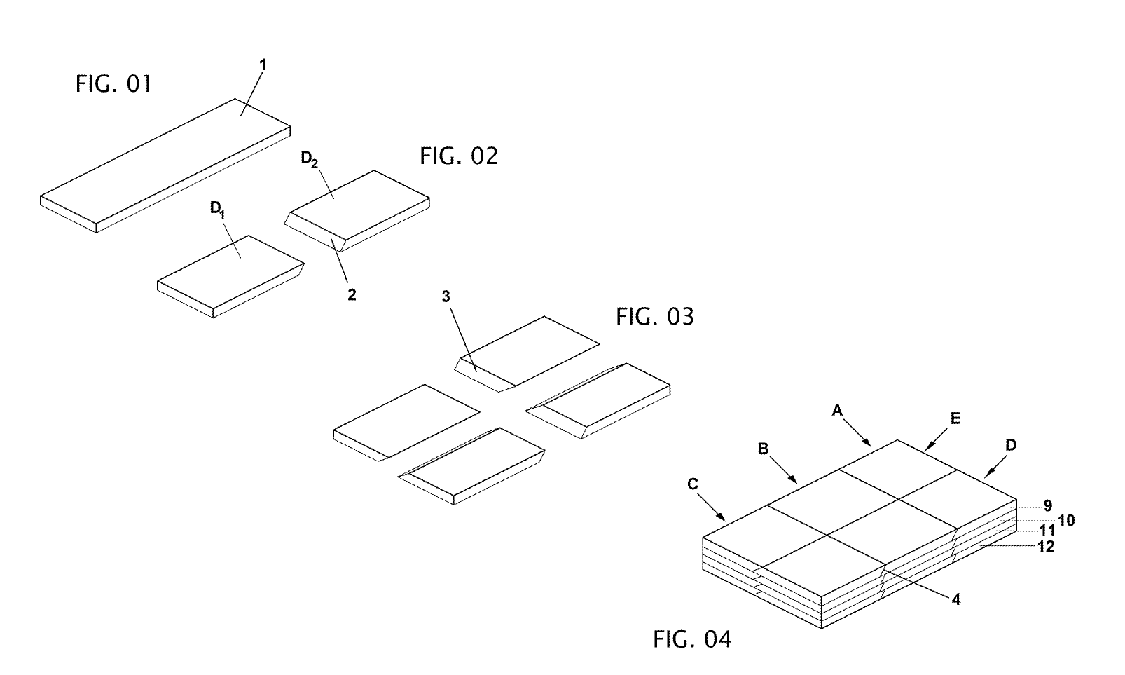

FIG. 1 shows a foam sheet already cut;

FIG. 2 shows the sheet cut in half with a tilted crosscut;

FIG. 3 shows two sheets cut with a tilted crosscut, receiving a longitudinal tilted cut and;

FIG. 4 shows an example of double mattress with two sides for different body masses, three cross-sections and with multilayers of different densities.

For the proper understanding of the proposed mattress construction process, it is necessary to understand the systematic adopted to build a mattress.

In the proposed example, there is a double mattress for people with different height and weight.

Initially, it is necessary to take the couple's measures. This is shown in the following table 1, which serves as an example:

| | | | SHOUL- | | |
|---|---|---|---|---|---|
| | WEIGHT | HEIGHT¹ | DERS² | HIPS³ | |
| | (Kg) | (cm) | (cm) | (cm) | NAME |
| RIGHT SIDE | 53.00 | 166.00 | 39.00 | 37.00 | XX |
| LEFT SIDE | 83.00 | 175.00 | 45.00 | 39.00 | XY |

¹User's height.
²Shoulders width.
³Hips width.

The double mattress shall have a height of 29.00 cm on the left side and on the right side.

Applying the equations corresponding to the solution algorithm to build the mattress, the following results are obtained, as shown in table 2:

| | | | |
|---|---|---|---|
| FOAM HEIGHT | | FOAM HEIGHT | |
| 20 cm | LEFT SIDE | 20 cm | RIGHT SIDE |

| COMFORT LAYER 2 cm | | | COMFORT LAYER 2 cm | | |
|---|---|---|---|---|---|
| RABATAN: RABATAN FOAM 1.34 × 1.84 | | | RABATAN: RABATAN FOAM 1.34 × 1.84 | | |
| S 30 - 4 cm | S 60 - 4 cm | D 33 - 4 cm | NASA 4 cm | S 30 - 4 cm | D 28 - 4 cm |
| NASA 4 cm | S 50 - 4 cm | D 28 - 4 cm | S 30 - 4 cm | S 50 - 4 cm | D 28 - 4 cm |
| S 30 - 4 cm | D 45 - 4 cm | D 33 - 4 cm | S 30 - 4 cm | D 33 - 4 cm | D 28 - 4 cm |

| | |
|---|---|
| ORTHOPEDIC BOX | ORTHOPEDIC BOX |
| D 20 - 2 cm | D 20 - 2 cm |

Where: S = Latex viscoelastic foam. D: Density. NASA: Viscoelastic foam. Rabatan: polyurethane foam.

The factory receives the order, the factory engineering reviews the order, and PCP (production scheduling and control) releases production according to the data obtained from the couple (Table 1).

Materials are separated according to OP (production order) and forwarded to the production line.

First, the foam sheets (1) are cut according to the mattress dimensions and according to need of foam types with different densities, as many as the layers used, right and left sides and cross-sections in which it will be applied.

After the sheets are cut, special cuts are made, diagonal cut (2 and 3) to increase the contact area, where the inserts (4) of each type of foam are set to be joined/welded (they are glued with hotmelt glue).

Next, assembly begins, where each part of the mattress, each foam (5, 6, 7 and 8), component, therapy, massage, accessories, are incorporated.

In the next step, the mattress is already mounted and without bedding (without fabrics), and it goes to the sewing sector, where it is covered with side fabric, top fabric, bottom fabric, edgings, labels, bands, etc.

After closing of the mattress in the sewing sector (bedding), the unit goes through the quality sector, where it is reviewed, tested and evaluated.

When released, it goes to the packing sector and then sent to the shipping sector.

In an example of a product manufactured in compliance with the production steps, a double mattress was manufactured with two sides divided longitudinally, respectively, left side (L_{E}) and right side (L_{D}), each of these sides having been divided into two cross-sections (A and B) or more (C), according to the mass values assigned to shoulders, hips and other parts (for example, legs), establishing different densities, where each of these sections contains layers (9, 10, 11 and 12).

A mattress manufactured in accordance with this procedure will be a tailor-made product, that is, exclusive to the single person or couple who ordered it. Therefore, despite being produced by an industry, the mattress described in the process will not go into mass production, and it will not be a product manufactured in batches or series, since the measured characteristics of the user or couple are unique, resulting in a product that will only fit the person who ordered it.

This differentiation is important to separate mattresses known as “tailored”, but made in series, from the mattress described in this process which is manufactured for each case and cannot be serial.

1. MATTRESS MANUFACTURING PROCESS AND RESPECTIVE RESULTING PRODUCT, the process comprising: determining whether the mattress is for a couple or a single person; after the determining step, establishing whether or not there will be a longitudinal division on the right side (L_{D}) and left side (L_{E}); measure body weight (kg), height (cm), shoulders width (cm) and hips width (cm) of the user, if the mattress is for a single person, or both users if the mattress is for a couple; and establishing, with these measures, the different density ranges for each of the layers (9, 10, 11 and 12) and for each of the sections (A and B).

2. MATTRESS MANUFACTURING PROCESS, according to claim 1 further comprising: cutting the sheets (1) in user(s) dimensions and according to the densities specified from the values obtained with body weight, height, shoulders and hips width; each of these sheets (1), separated according to their densities (D₁ and D₂), receiving tilted side cuts (2 and 3) on each side; and assembling sections (A and B) in multilayers (9, 10, 11 and 12) joining these layers on the diagonal cuts (2 and 3).

3. MATTRESS MANUFACTURING PROCESS, according to claim 1, wherein the right side (L_{D}) and left side (L_{E}) may be divided into more sections (A, B and C) and have each of these sections can have multilayers (9, 10, 11 and 12).

4. MATTRESS, manufactured according to the manufacturing process set forth in claim 1, and wherein the mattress can be divided into two sides (L_{D} and L_{E}), and each of these sides can be divided into sections (A, B and C), as many as the measures determined for each body region, and each one of these sections (A, B and C) may have multiple layers (9, 10, 11 and 12), where each of these layers presents different density, so that the mattress is a combination of sides, sections and layers.

5. MATTRESS, manufactured according to the manufacturing process set forth in claim 2, and wherein the mattress can be divided into two sides (L_{D} and L_{E}), and each of these sides can be divided into sections (A, B and C), as many as the measures determined for each body region, and each one of these sections (A, B and C) may have multiple layers (9, 10, 11 and 12), where each of these layers presents different density, so that the mattress is a combination of sides, sections and layers.

6. MATTRESS, manufactured according to the manufacturing process set forth in claim 3, and wherein the mattress can be divided into two sides (L_{D} and L_{E}), and each of these sides can be divided into sections (A, B and C), as many as the measures determined for each body region, and each one of these sections (A, B and C) may have multiple layers (9, 10, 11 and 12), where each of these layers presents different density, so that the mattress is a combination of sides, sections and layers.
